(19) United States
(12) Patent Application Publication
(10) Pub. No.: US 2025/0104895 A1
(43) Pub. Date: Mar. 27, 2025

(54) MIM MAGNETS

(71) Applicant: Apple Inc., Cupertino, CA (US)

(72) Inventors: John C. DiFonzo, Redwood City, CA (US); Eric X. Zhou, Mountain View, CA (US); Christopher S. Graham, San Francisco, CA (US); Karl Ruben Fredrik Larsson, Scotts Valley, CA (US)

(73) Assignee: Apple Inc., Cupertino, CA (US)

(21) Appl. No.: 18/896,214

(22) Filed: Sep. 25, 2024

Related U.S. Application Data
(60) Provisional application No. 63/540,775, filed on Sep. 27, 2023.

(51) Int. Cl. H01F 7/02; H01F 1/053

(52) U.S. Cl. CPC H01F 7/02; H01F 1/053

(57) ABSTRACT

Examples provide magnets for electronic devices. The magnets can be formed as unitary structures using metal-injection molding. The magnets can be referred to as neodymium magnets. That is, they can be formed of neodymium, iron, and boron. The magnet can comprise a plurality of easy axes, where the plurality of easy axes are not parallel.

### CROSS-REFERENCES TO RELATED APPLICATIONS

This application claims the benefit of U.S. Provisional Application No. 63/540,775, filed on Sep. 27, 2023, which is incorporated by reference.

### BACKGROUND

The number of types of electronic devices that are commercially available has increased tremendously the past few years and the rate of introduction of new electronic devices shows no signs of abating. Electronic devices such as tablet computers, laptop computers, all-in-one computers, desktop computers, smart phones, storage devices, wearable-computing devices, portable media players, portable computing devices, navigation systems, monitors, audio devices, remotes, adapters, and others have become ubiquitous.

These electronic devices often include magnets for various reasons. Magnets can be used to attach two electronic devices together. Magnets can be used to attach an electronic device to an accessory. Magnets can be used to secure one portion of an electronic device to another portion of the electronic device.

More specific examples can include magnets that can secure an audio device in a case for charging. Other magnets can secure the case in a closed position. Magnets can be used on a smart phone to attach and align wallets, battery packs, chargers, camera adapters, and other accessories. Magnets can be used to attach tablet computers to keyboards and other input devices.

But these magnets can consume space in their electronic devices. The use of this space can necessitate an increase in the size of an electronic device housing a magnet, a decrease in functionality of the electronic device, or both.

Also, conventional magnet manufacturing can result in the generation of unused resources. For example, excess material can be carved away to generate a magnet having a specific shape or form factor. While these resources can be recycled or reused, additional resources are required to do so.

Thus, what is needed are magnets that are stronger, smaller, or both, and are readily manufactured, as well as methods and apparatus that enable the manufacturing of magnets with a reduced amount of resources.

### SUMMARY

Accordingly, embodiments of the present invention can provide magnets that are stronger, smaller, or both, and are readily manufactured, as well as methods and apparatus that enable the manufacturing of magnets with a reduced amount of resources.

An illustrative embodiment of the present invention can provide unitary magnets that have a stronger magnetic field as compared to a combination of magnets. The magnets can be formed as a single piece using a metal-injection molding or other process. The magnets can be neodymium magnets. That is, the magnets can be formed of neodymium, iron, and boron (NdFeB or NIB.) In these and other embodiments of the present invention, other materials, such as rare earth materials, can be used. Samarium-cobalt, manganese-bismuth, or other materials can be used. Ferritic materials can also be used.

Conventional magnets for electronic devices can be formed of several magnets attached together. Each of the individual magnets can include an easy axis that is formed in one direction. The combination of magnets can be proximally arranged and fixed together, for example using epoxy or other adhesive, a holder, a magnetic shield, or other structures. But this can be inefficient and can result in large magnetic structures. Accordingly, embodiments of the present invention can provide unitary magnets that can include easy axes that are positionable in three dimensions. Using such a unitary magnet can be more efficient. This efficiency can reduce the size of the needed magnet, thereby conserving resources. This can reduce the volume needed for the magnet in an electronic device, can provide a stronger magnetic field, or a combination of these. This efficiency can also reduce excess or unwanted magnetic flux around the magnet and the electronic device, thereby offering some protection to magnetically stored information, such as that on a credit card.

These and other embodiments of the present invention can provide magnets that are readily manufactured. For example, the magnets can be formed by metal-injection molding or other molding process. Multiple magnets can be used to enforce multiple pole directions in the magnet while the magnet is being formed. That is, multiple magnets can be positioned around the molding while the magnet is being formed. The multiple magnets can be permanent magnets, pole pieces, electromagnets, or combinations of these and other magnetic structures. The multiple magnets can cause domains on outside surfaces of grains to be pinned in different directions in the same magnet such that the easy axis of the magnet have a curvature. This can allow a single magnet to mimic a number of magnets positioned proximally to each other.

Using a metal-injection molding process can conserve resources needed to form magnets for electronic devices. Conventional magnets can be formed by starting with a block of magnetic material and then removing excess magnetic material until a magnet having the desired form factor remains. The excess material can be recaptured, but the recaptured material requires further processing before it can be reused, and this further processing can require additional resources. Accordingly, these and other embodiments of the present invention can utilize metal-injection or other molding when forming a magnet. Only enough magnetic material needed for the actual magnet, as well as smaller excess pieces such as gate vestiges and parting lines, are used, thereby conserving resources. The smaller excess pieces, such as gate vestiges and parting lines, can be trimmed from the finished magnets and readily reused without further processing, or with only minimal processing, in the manufacture of further magnets, which can further conserve resources.

These and other embodiments of the present invention can provide various types of magnets. For example, an embodiment of the present invention can provide a magnet having shapes that might not be achievable with conventional methods. Embodiments of the present invention can provide a unitary magnet having adjacent surfaces that meet to form one or an acute or obtuse angle. This can be particularly useful in fitting a magnet it a small space in a small electronic device, such as an earbud or other electronic device.

An embodiment of the present invention can provide a magnet that replaces a plurality of magnets. The replaced plurality of magnets can include a curved surface. The easy axis direction for each of the plurality of magnets can be orthogonal to the curved surface. Embodiments of the present invention can provide a unitary magnet having an easy axis direction that forms at least approximately a 180 turn in the magnet.

An embodiment of the present invention can provide a magnet that replaces a magnet that has a first polarity at a first side, a second polarity at a second side, and a center that does not have a magnetic polarity. Embodiments of the present invention can provide a unitary magnet that has a first easy axis direction in a first direction at a first side and a second easy axis direction in a second direction at a second side. The middle of the unitary magnet can further have a third easy axis direction having a polarity pointing in a third direction, where the third direction is from the second side to the first side. The first easy axis direction and the second easy axis direction can converge in one of an acute or obtuse angle. The third easy axis direction in the middle of the magnet can allow the unitary magnet to be more efficient and therefore have a stronger magnetic field, smaller size, or a combination thereof. These different easy axes directions can provide polarities that are non-parallel, and that can be non-antiparallel.

An embodiment of the present invention can provide a magnet that replaces a magnet array. The unitary magnet can include an array of sections having different easy axes, wherein each section provides a first polarity or a second polarity facing a surface of an electronic device, and wherein each row in the array comprises a section providing the first polarity and a section having the second polarity facing the surface, and each column in the array comprises a section having the first polarity and a section having the second polarity facing the surface.

An embodiment of the present invention can mimic (or implement the function of) a Halbach array using a unitary magnet. These embodiments can provide a unitary magnet where a strength of a magnetic field on a first side of the magnet is stronger than the magnetic field on a second side of the magnet.

These and other embodiments of the present invention can provide other shaped magnets. For example, embodiments can provide conventional bar magnets. Such a bar magnet can be made more efficiently, since bar magnets that are commercially available might not be available in an exact size that is needed, so material would still need to be removed to form the bar magnet. Also, embodiments can provide a stronger magnet that might be commercially available. Other shapes, such as plus-sign or “X” shaped magnets, annular magnets, “S” shaped magnets, horseshoe-shaped magnets, or other shaped magnets can be formed using embodiments of the present invention.

Embodiments of the present invention can provide unitary magnets having different easy axis directions at different locations. Also, embodiments can provide unitary magnets having one polarity direction throughout the magnet. Such a magnet can be made more efficiently, since magnets that are commercially available might not be available in an exact size that is needed, so material would still need to be removed to form a magnet having one polarity direction. Also, embodiments can provide a stronger magnet that might be commercially available.

Various embodiments of the present invention can incorporate one or more of these and the other features described herein. A better understanding of the nature and advantages of the present invention can be gained by reference to the following detailed description and the accompanying drawings.

### BRIEF DESCRIPTION OF THE DRAWINGS

FIG. 1A and FIG. 1B illustrate a magnet according to an embodiment of the present invention;

FIG. 2A illustrates a group of magnets and FIG. 2B illustrates a unitary magnet according to an embodiment of the present invention that can replace the group of magnets of FIG. 2A;

FIG. 3 illustrates a unitary magnet according to an embodiment of the present invention;

FIG. 4A illustrates a group of magnets and FIG. 4B illustrates a unitary magnet according to an embodiment of the present invention that can replace the group of magnets of FIG. 4A;

FIG. 5A illustrates a magnet and FIG. 5B illustrates a unitary magnet according to an embodiment of the present invention that can improve upon the magnet of FIG. 5A;

FIG. 6A illustrates an electronic device comprising a plurality of groups of magnets and FIG. 6B illustrates a plurality of unitary magnets that can replace the groups of magnets in FIG. 6A;

FIG. 7A illustrates a Halbach array formed of a number of magnets and FIG. 7B illustrates a unitary magnet implemented to mimic a Halbach array that can replace the magnets of FIG. 7A;

FIG. 8 illustrate a molding system that can be used in the manufacturing of a unitary molded magnet according to an embodiment of the present invention;

FIG. 9 illustrates processes involved in manufacturing a magnet according to an embodiment of the present invention;

FIG. 10 illustrates a method of manufacturing a magnet according to an embodiment of the present invention;

FIG. 11 illustrates a configuration for a coil that can be used during the manufacturing of magnets according to an embodiment of the present invention;

FIG. 12 illustrates a configuration for coils that can be used during the manufacturing of magnets according to an embodiment of the present invention; and

FIG. 13 illustrates a configuration for coils that can be used during the manufacturing of magnets according to an embodiment of the present invention.

### DESCRIPTION OF ILLUSTRATIVE EMBODIMENTS

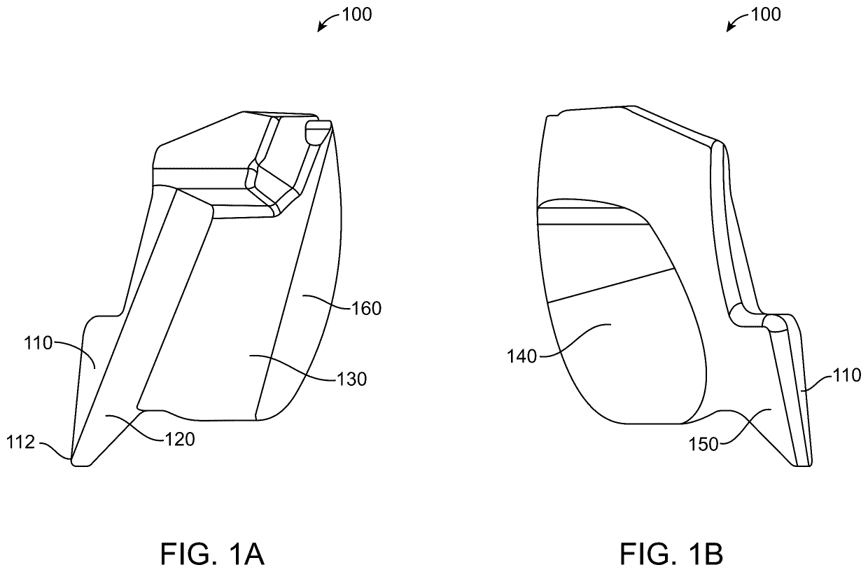

FIG. 1A and FIG. 1B illustrate a unitary magnet according to an embodiment of the present invention. Magnet 100 can include several curved, acute, obtuse, tapered, and other non-orthogonal surfaces and intersections of surfaces. For example, magnet 100 can include curved surface 140. Magnet 100 can include surfaces 110 and 150 that can meet to form an acute angle. Surfaces 120 and 130 can meet to form an obtuse angle. Magnet 100 can also include surfaces 110, 120, and 150 that can meet at tapered point 112. These various contours can be provided using metal-injection molding or other techniques provided by embodiments of the present invention. These contours would be extremely difficult or impossible to machine from a block.

Easy axes (not shown) can be in different directions in different portions of magnet 100. As a result, the pole direction for magnet 100 can be non-linear. For example, a pole direction can be into surface 130 and out of surface 160, which can be non-opposing sides. A pole direction can be orthogonal or normal to surface 140 over its curvature. That is, the easy axis at different locations of magnet 100 can be nonparallel. In these and other embodiments of the present invention, a magnet might have one polarity direction. For example, magnet 100 can be formed having one polarity direction.

Unitary magnet 100 can be formed by a metal-injection molding or other molding process. Using a metal-injection molding or other molding process can provide unitary magnet 100 with a shape, features, and nonlinear or nonparallel magnetic field characteristics that might be impossible or difficult to otherwise manufacture, particularly in large volumes. Unitary magnet 100 can be referred to as a neodymium magnet. That is, magnet 100 can be formed of neodymium, iron, and boron (NdFeB.) In these and other embodiments of the present invention, other materials, such as rare earth materials can be used, such as samarium-cobalt, manganese-bismuth, or other material. Ferritic materials can also be used. Powdered neodymium, iron, and boron (NdFeB) can be formed by grinding crystalline NdFeB and combined with a binder to generate a feedstock. The feedstock can be heated and injected into a mold. A magnetic field can be applied to the mold to enforce nonparallel easy axes. The molded magnet can be debound, that is the binding agent can be removed. The molded magnet can be sintered and the result can then be used in an electronic device. Portions of the molded magnet, such as gate vestiges and parting lines, can be removed before or after sintering and reused as feedstock. The molded magnet can include voids or open areas within its volume. For example, unitary magnet 100 can include two, three, four, or other percent voids.

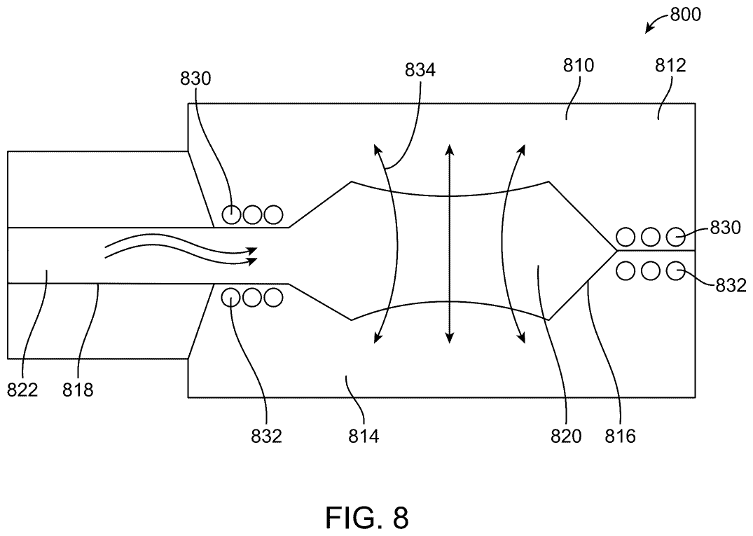

A magnetic field can be applied to magnet 100 during the molding process to enforce a nonlinear pole direction for magnet 100. That is, a magnetic field can be applied to magnet 100 during the molding process to enforce a nonlinear easy axis for magnet 100. These magnets can be permanent magnets, magnetic elements such as pole pieces, electromagnets, or other structures capable of conveying or generating a magnetic field, or a combination of these. An example is shown in FIG. 8. Examples of other magnets that can have nonlinear or nonparallel easy axes are shown in the following figures.

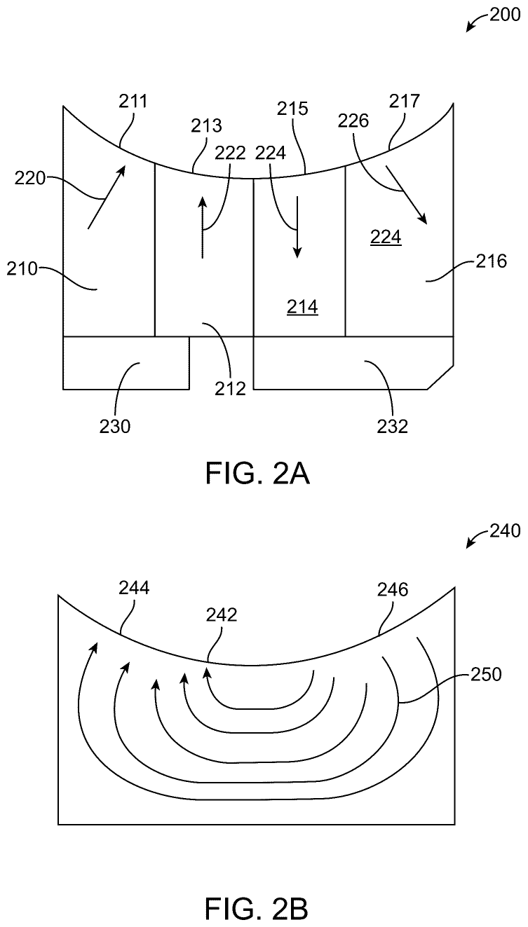

FIG. 2A illustrates a group of magnets and FIG. 2B illustrates a unitary magnet according to an embodiment of the present invention that can replace the group of magnets of FIG. 2A. FIG. 2A illustrates a group of magnets 200 including magnets including magnet 210, magnet 212, magnet 214, and magnet 216. Magnet 210, magnet 212, magnet 214, and magnet 216 can be held together and supported by base 230 and base 232. Magnet 210, magnet 212, magnet 214, magnet 216, base 230, and base 232 can be held together using adhesive or other material. Magnet 210 can include easy axis directions 220 that are approximately orthogonal to a surface 211. Magnet 212 can include easy axis directions 222 that are approximately orthogonal to a surface 213. Magnet 214 can include easy axis directions 224 that are approximately orthogonal to a surface 215. Magnet 216 can include easy axis directions 226 that are approximately orthogonal to a surface 217.

Magnet 210 and magnet 212 can have poles of a first polarity that can be positioned such they are at least approximately orthogonal to surfaces 211 and 213, respectively. Magnet 214 and magnet 216 can have poles of a second polarity that can be positioned such they are at least approximately orthogonal to surfaces 215 and 217, respectively. The easy axis for each of the magnets, magnet 210, magnet 212, magnet 214, and magnet 216, can be oriented in the direction of their easy axis directions, easy axis direction 220, easy axis direction 222, easy axis direction 224, and easy axis direction 226.

FIG. 2B illustrates a unitary magnet according to an embodiment of the present invention that can replace the group of magnets of FIG. 2A. Unitary magnet 240 can include curved surface 242 having first portion 244 and second portion 246. Easy axis directions 250 can be approximately orthogonal to portion 246 of surface 242 and they can be approximately orthogonal to portion 244 of surface 242. This can result in portion 246 of surface 242 having a first polarity and portion 244 of surface 242 having a second polarity.

Magnet 240 can have a pole of a first polarity that can be positioned such it is at least approximately orthogonal to portion 244 of surface 242. Magnet 240 can have a pole of a second polarity that can be positioned such it is at least approximately orthogonal to portion 246 of surface 242. The polarity of magnet 240 can follow curved lines that can be oriented in the direction of easy axis directions 250.

Magnet 240 can be a unitary magnet. That is, magnet 240 can be formed as a single piece. As such, base 230 and base 232, shown in FIG. 2A, are not needed, though a base (not shown) can be used to fix magnet 240 in position in an electronic device. Also, there is no need for adhesives or other materials to attach portions of magnet 240 together since it is a unitary magnet. This can reduce the number of parts needed to manufacture the electronic device and can simplify its assembly, conserve resources, and reduce rework. This can also result in a smaller unitary magnet 240 that saves space as compared to group of magnets 200. This space savings can allow an electronic device that includes unitary magnet 240 to be smaller, it can allow the electronic device to include more functionality, or both. While easy axis directions 250 are shown as converging, unitary magnet 240 can include diverging easy axis directions.

Magnet 240 can be formed by a metal-injection molding or other molding process. Magnet 240 can be referred to as a neodymium magnet. That is, magnet 240 can be formed of neodymium, iron, and boron. In these and other embodiments of the present invention, other materials, such as rare earth materials can be used, such as samarium-cobalt, manganese-bismuth, or other material. Ferritic materials can also be used. Powdered neodymium, iron, and boron (NdFeB) can be formed by grinding crystalline NdFeB and combined with a binder to generate a feedstock. The feedstock can be heated and injected into a mold. A magnetic field can be applied to the mold to enforce nonparallel easy axes. The molded magnet can be debound, that is the binding agent can be removed. The molded magnet can be sintered and the result can then be used in an electronic device. Portions of the molded magnet, such as gate vestiges and parting lines, can be removed before or after sintering and reused as feedstock. The molded magnet can include voids or open areas within its volume. For example, unitary magnet 240 can include two, three, four, or other percent voids.

A magnetic field can be applied to magnet 240 during the molding process to enforce a nonlinear pole direction for magnet 240. That is, a magnetic field can be applied to magnet 240 during the molding process to enforce a nonlinear easy axis for magnet 240. The magnetic field can be generated using permanent magnets, pole pieces, electromagnets, or combinations of these and other magnetic structures. An example is shown in FIG. 8. In this example, easy axis directions 250 can be enforced in various ways during the manufacturing process. For example, electromagnets having windings around a U-shaped core that follows the contours of the desired easy axis directions 250 can be positioned near a front and back sides (where the front side is viewed in FIG. 2B) of magnet 240. Current flow through the windings can enforce domains in magnet 240 to align in a curved manner to generate the desired easy axis directions 250.

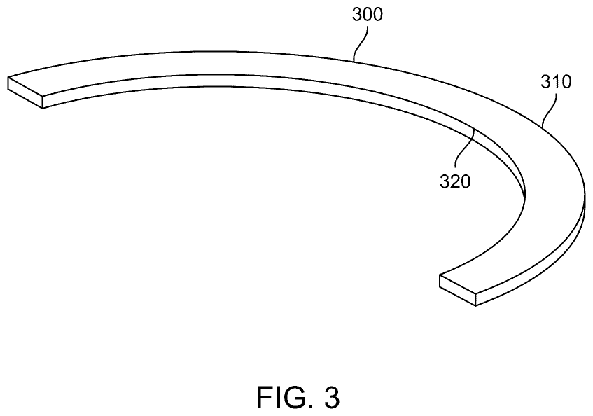

FIG. 3 illustrates a unitary magnet according to an embodiment of the present invention. Magnet 300 can have a first side 310 along an outer perimeter and a second side 320 along an inner perimeter. Magnet 300 can have a shape that is an arc of a circle. In this example, magnet 300 can have the shape of a semicircle, though in other examples magnet 300 can be less than one-half a circle or more than one-half of a circle, for example magnet 300 can instead be a full circle. Magnet 300 can be one of two magnets that can be put together to form a full circle. A pair of semicircular magnets can be used in each of two compatible electronic devices to provide an attachment mechanism between the electronic devices. The easy axis directions can be different for each pair of semicircular magnets. Examples are shown in the following figures.

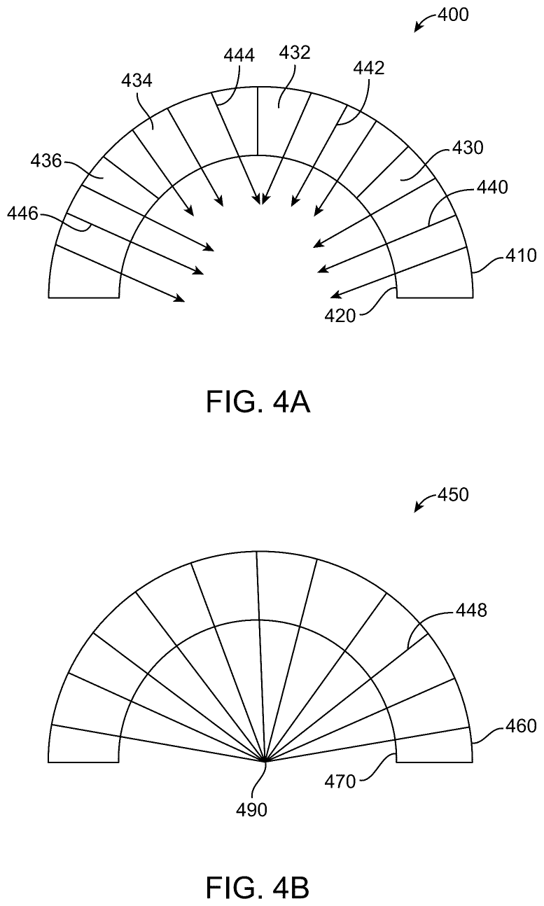

FIG. 4A illustrates a group of magnets and FIG. 4B illustrates a unitary magnet according to an embodiment of the present invention that can replace the group of magnets of FIG. 4A. FIG. 4A illustrates a group of magnets 400 including magnet 430, magnet 432, magnet 434, and magnet 436. Magnet 430, magnet 432, magnet 434, and magnet 436 can be held together using a base, shield, or other structure, an adhesive, such as epoxy, or other structure, material, or combination of structures or materials. Magnet 432, magnet 434, and magnet 436 can have outer edge 410 along an outer perimeter and inner edge 420 along an inner parameter.

Magnet 430 can have easy axis directions 440. Easy axis directions 440, as with the other easy axis directions shown in this example, can be in parallel with each other and can extend from outer edge 410 to inner edge 420. Magnet 432 can have easy axis directions 442, which can also be in parallel with each other. Similarly, magnet 434 can have parallel easy axis directions 444 and magnet 436 can have parallel easy axis directions 446. The parallel easy axis directions can tend to converge in a center of the circle defined by the arc made by group of magnets 400, though actual convergence is not achievable since easy axis directions are parallel to each other within each magnet. Accordingly, embodiments of the present invention can provide a unitary magnet to replace the group of magnets 400. The unitary magnet can have easy axis directions that converge at a center point of the circle defined by the arc made by the unitary magnet. An example is shown in FIG. 4B.

FIG. 4B illustrates a unitary magnet according to an embodiment of the present invention that can replace the group of magnets of FIG. 4A. Since magnet 450 is a unitary magnet, magnet 450 does not need to be held together using a base, shield, epoxy, or other material, thereby simplifying an assembly process for an electronic device housing unitary magnet 450. Some of these or other materials might be used to secure unitary magnet 450 in place in the electronic device. Unitary magnet 450 can be more efficient, allowing unitary magnet 450 to be smaller. This reduced size can save space in an electronic device, allow additional functionality to be included in the electronic device, or a combination of both.

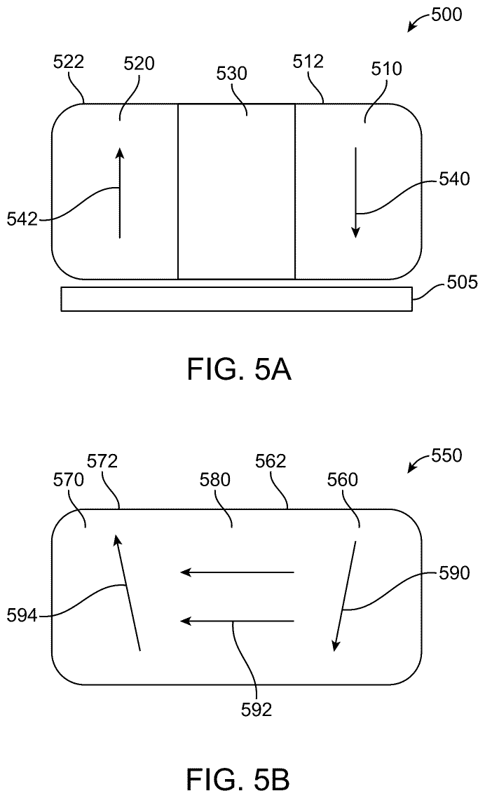

Unitary magnet 450 can have an outer edge 460 along an outer perimeter and inner edge 470 along an inner parameter. Easy axis directions 448 can extend in the direction from outer edge 460 to inner edge 470. Easy axis directions 448 can converge at a center 490 of the circle defined by the arc shape of unitary magnet 450. This can help to increase an attraction between magnet 450 in a first electronic device and a magnet such as unitary magnet 550 (shown in FIG. 5B.) Unitary magnet 450 can have polarity directions that are truly radial rather than polygonal, which can add to the electromagnetic efficiency.

Unitary magnet 450 can have a pole of a first polarity that can be positioned along the outer edge 460 of magnet 450. Unitary magnet 450 can have a pole of a second polarity that can be positioned along the inner edge 470 of magnet 450. The magnet 450 can generate field lines that can follow the direction of easy axis directions 448.

Unitary magnet 450 can be formed by a metal-injection molding or other molding process. Magnet 450 can be referred to as a neodymium magnet. That is, the magnet 450 can be formed of neodymium, iron, and boron. In these and other embodiments of the present invention, other materials, such as rare earth materials can be used, such as samarium-cobalt, manganese-bismuth, or other material. Ferritic materials can also be used. Powdered neodymium, iron, and boron (NdFeB) can be formed by grinding crystalline NdFeB and combined with a binder to generate a feedstock. The feedstock can be heated and injected into a mold. A magnetic field can be applied to the mold to enforce nonparallel easy axes. An example is shown in FIG. 8. The molded magnet can be debound, that is the binding agent can be removed. The molded magnet can be sintered and the result can then be used in an electronic device. Portions of the molded magnet, such as gate vestiges and parting lines, can be removed before or after sintering and reused as feedstock. The molded magnet can include voids or open areas within its volume. For example, unitary magnet 450 can include two, three, four, or other percent voids.

A magnetic field can be applied to magnet 450 during the molding process to enforce a nonlinear pole direction for magnet 450. That is, a magnetic field can be applied to magnet 450 during the molding process to enforce a nonlinear easy axis for unitary magnet 450. The magnetic field can be generated using permanent magnets, pole pieces, electromagnets, or combinations of these and other magnetic structures. In this example, easy axis directions 448 can be enforced in various ways during the manufacturing process. For example, a first polarity of a magnet can be positioned in center 490 of a circle defined by the arc of magnet 450. Second polarities of magnets can be placed along outer edge 460 of magnet 450. This can create a magnetic field that can align grains of magnet 450 during molding such that the finished magnet 450 has easy axis directions 448.

FIG. 5A illustrates a magnet and FIG. 5B illustrates a unitary magnet according to an embodiment of the present invention that can improve upon the magnet of FIG. 5A. FIG. 5A illustrates a magnet 500. Magnet 500 can be supported by a shield 505 or other structure. Magnet 500 can have a first end 510 and a second end 520. Magnet 500 can have a non-magnetized portion 530 between first end 510 and second end 520. First end 510 can have an easy axis direction to generate polarity 540 while second end 520 can have an easy axis direction to generate polarity 542. Polarity 540 and polarity 542 can be parallel. That is, the easy axis direction generating polarity 540 and the easy axis direction generating polarity 542 can be nonconverging.

The easy axis for first end 510 can be in the same direction as the easy axis for second end 520. The pole directions for first end 510 and second end 520 can be opposing directions. First end 510 can have a pole having a first polarity at a surface 512 while second end 520 can have a pole having a second polarity at a surface 522.

Portion 530 of magnet 500 is not magnetized, or at least not magnetized strongly. For example, first end 510 of magnet 500 can be magnetized in a first direction while second end 520 of magnet 500 can be magnetized in a second opposing direction. Given the limitations of magnetizers, portion 530 is not magnetized. To complete a path for the magnetic flux of magnet 500, a shield 505 can be used.

More specifically, magnet 500 can be one in a group of magnets forming an arc. This can be the same as or similar to the group of magnets 400 (shown in FIG. 4A.) That is, magnet 500 can have a top view that is the same as or similar to magnet 400 (shown in FIG. A.) A first circular magnet can be formed of the group of magnets 500 and placed in a first electronic device (not shown.) A second electronic device (not shown) can include two magnets 450 (shown in FIG. 4B.) Magnet flux from first end 510 of magnet 500 can pass through shield 505, thereby bypassing non-magnetized portion 530, and through second end 520 of magnet 500. The magnet flux can pass from outer edge 460 to inner edge 470 of unitary magnet 450, and back to first end 510 of magnet 500.

Magnet 500 can therefore have several limitations. Multiple magnets 500 are needed to form a semicircular arc. Also, non-magnetized portion 530 can reduce an effectiveness of magnet 500 and decrease the strength of the magnetic field of magnet 500. Because of the presence of non-magnetized portion 530, a shield might need to be used with magnets 500 to generate enough of a field to attach two electronic devices together. Accordingly, embodiments of the present invention can provide unitary magnets that can each form a semicircular magnet and does not include a non-magnetized portion such that a shield is not necessary. An example is shown in the following figure.

FIG. 5B illustrates a unitary magnet according to an embodiment of the present invention that can improve upon the magnet of FIG. 5A. FIG. 5A illustrates unitary magnet 500. Magnet 500 can be supported by a shield, plastic housing, or other structure when assembled into an electronic device. Magnet 500 can have a first end 560 and a second end 570. Magnet 500 can have a laterally magnetized portion 580 between first end 560 and second end 570. First end 560 can have an easy axis direction generating polarity 590 while second end 570 can have an easy axis direction generating polarity 594. Portion 580 can have an easy axis direction generating polarity 592 extending from first end 560 to second end 570. The easy axis direction generating polarity 590 and the easy axis direction generating polarity 592 can be non-parallel easy axis directions. That is, the easy axis direction generating polarity 540 and the easy axis direction generating polarity 542 can be converging easy axis directions.

The easy axis for first end 560 can be in a different direction as the easy axis for second end 570. The pole directions for first end 560 and second end 570 can be essentially opposing directions but nonparallel and converging. First end 560 can have a pole having a first polarity at a surface 562 while second end 570 can have a pole having a second polarity at a surface 572.

Portion 580 of magnet 500 can magnetized, in contrast to portion 530 of magnet 500 (shown in FIG. 5A.) For example, first end 560 of magnet 550 can be magnetized in a first direction while second end 570 of magnet 550 can be magnetized in somewhat close to a second opposing direction. Portion 580 can be magnetized in a direction from first end 560 to second end 570. This can complete a path for the magnetic flux of magnet 550 without the need for a shield.

More specifically, magnet 550 can be a unitary magnet forming an arc, such as a semicircle, though magnet 500 can outline more than or less than one-half a circle. This can be the same as or similar to magnet 450 (shown in FIG. 4B.) That is, magnet 550 can have a top view that is the same as or similar to magnet 450 (shown in FIG. B.) A first circular magnet can be formed using two magnets 550 and placed in a first electronic device (not shown.) A second electronic device (not shown) can include a circular magnet formed of two magnets 450 (shown in FIG. 4B.) Magnet flux from first end 560 of magnet 550 can pass through portion 580 without the need of a shield, and through second end 570 of magnet 550. The magnetic flux can pass from outer edge 460 to inner edge 470 of unitary magnet 450, and back to first end 560 of magnet 550. In this way, unitary magnets 450 and unitary magnets 550 can form a strong magnetic attraction between the first electronic device and the second electronic device.

Unitary magnet 550 can be formed by a metal-injection molding or other molding process. Magnet 550 can be referred to as a neodymium magnet. That is, the magnet 550 can be formed of neodymium, iron, and boron. In these and other embodiments of the present invention, other materials, such as rare earth materials can be used, such as samarium-cobalt, manganese-bismuth, or other material. Ferritic materials can also be used. Powdered neodymium, iron, and boron (NdFeB) can be formed by grinding crystalline NdFeB and combined with a binder to generate a feedstock. The feedstock can be heated and injected into a mold. A magnetic field can be applied to the mold to enforce nonparallel easy axes. An example is shown in FIG. 8. The molded magnet can be debound, that is the binding agent can be removed. The molded magnet can be sintered and the result can then be used in an electronic device. Portions of the molded magnet, such as gate vestiges and parting lines, can be removed before or after sintering and reused as feedstock. The molded magnet can include voids or open areas within its volume. For example, unitary magnet 550 can include two, three, four, or other percent voids.

A magnetic field can be applied to magnet 550 during the molding process to enforce a nonlinear pole direction for magnet 550. That is, a magnetic field can be applied to magnet 550 during the molding process to enforce a nonlinear easy axis for unitary magnet 550. The magnetic field can be generated using permanent magnets, pole pieces, electromagnets, or combinations of these and other magnetic structures. In this example, easy axis directions generating polarities 590, 592, and 594 can be enforced in various ways during the manufacturing process. For example, an electromagnet can be placed above magnet 550, where the electromagnet can be curved to follow the semicircular contour of magnet 550. A resulting magnetic field can be around magnet 550 that can align grains of magnet 550 during molding such that the finished magnet 550 has easy axis directions generating polarities 590, 592, and 594.

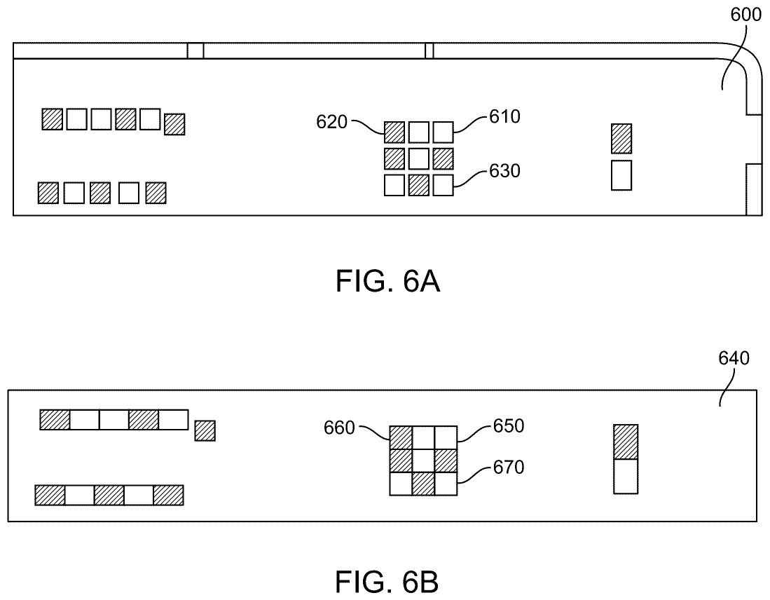

FIG. 6A illustrates an electronic device comprising a plurality of groups of magnets and FIG. 6B illustrates a plurality of unitary magnets that can replace the groups of magnets in FIG. 6A. FIG. 6A illustrates a magnet array 610 having a number of magnets 620 with a first pole facing a bottom surface (as drawn) of electronic device 600 and a number of magnets 630 with a second pole facing a bottom surface of electronic device 600. Each row in magnet array 610 can include one or more magnets with a first pole and one or more magnets with a second pole facing a bottom of electronic device 600. Each column in the magnet array 610 can include one or more magnets with a first pole and one or more magnets with a second pole facing a bottom of electronic device 600. The magnet array 610 can be used to attach a second electronic device (not shown) to electronic device 600. For example, a second electronic device can include a group of magnets having opposing poles that attract magnet array 610, thereby attaching electronic device 600 to the second electronic device.

Magnet array 610 can be assembled by grouping nine magnets together, either by hand or by machine. In either event, this process can be time consuming and result in yield losses. Errors can result thereby requiring rework and consuming resources. Accordingly, embodiments of the present invention can replace the nine magnets used to form magnet array 610 with a single, unitary magnet. An example is shown in the following figure.

FIG. 6B illustrates a plurality of unitary magnets that can replace the groups of magnets in FIG. 6A. In this example, unitary magnet 650 can be used in place of magnet array 610 (shown in FIG. 6A.) Unitary magnet can have a number of sections 660 having a first pole and a number of sections 670 having a second pole facing a bottom surface (as drawn) of electronic device 640. Each row of sections in magnet 650 can include one or more sections 660 with a first pole and one or more sections 670 with a second pole facing a bottom of electronic device 640. Each column in the magnet array 610 can include one or more sections 660 with a first pole and one or more sections 670 with a second pole facing a bottom of electronic device 640. Unitary magnet 650 can be used to attach a second electronic device (not shown) to electronic device 640. For example, a second electronic device can include a group of magnets having opposing poles that attract unitary magnet 650, thereby attaching electronic device 640 to the second electronic device.

Using unitary magnet 650 can simplify manufacturing of electronic device 640. For example, a group of magnets don't need to be aligned and fixed to each other as in magnet array 610. Also, unitary magnet 650 can be smaller, thereby conserving space in electronic device 640 and enabling electronic device 640 to be smaller, include more functionality, or both. This can reduce assembly time, increase yield, decrease rework, and conserve resources.

Unitary magnet 650 can be formed by a metal-injection molding or other molding process. Magnet 650 can be referred to as a neodymium magnet. That is, the magnet 650 can be formed of neodymium, iron, and boron. In these and other embodiments of the present invention, other materials, such as rare earth materials can be used, such as samarium-cobalt, manganese-bismuth, or other material. Ferritic materials can also be used. Powdered neodymium, iron, and boron (NdFeB) can be formed by grinding crystalline NdFeB and combined with a binder to generate a feedstock. The feedstock can be heated and injected into a mold. A magnetic field can be applied to the mold to enforce nonparallel easy axes. The molded magnet can be debound, that is the binding agent can be removed. The molded magnet can be sintered and the result can then be used in an electronic device. Portions of the molded magnet, such as gate vestiges and parting lines, can be removed before or after sintering and reused as feedstock. The molded magnet can include voids or open areas within its volume. For example, unitary magnet 650 can include two, three, four, or other percent voids.

A magnetic field can be applied to magnet 650 during the molding process to enforce the various pole directions for sections of magnet 650. An example is shown in FIG. 8. That is, a magnetic field can be applied to magnet 650 during the molding process to enforce the different polarities for unitary magnet 650. The magnetic field can be generated using permanent magnets, pole pieces, electromagnets, or combinations of these and other magnetic structures. In this example, poles for sections 660 and sections 670 can be enforced in various ways during the manufacturing process. For example, a plurality of magnets can be placed above and below magnet 650 (where down is the direction into FIG. 6B.) The magnets below magnet 650 can have the same pattern as shown for magnet 650 facing a bottom side (not shown) of magnet 650. The magnets above magnet 650 can have the opposite pattern of polarities facing the top side (shown here) of magnet 650. A resulting magnetic field can align grains of magnet 650 during molding such that the finished magnet 650 has sections 660 and sections 670 with the desired polarity.

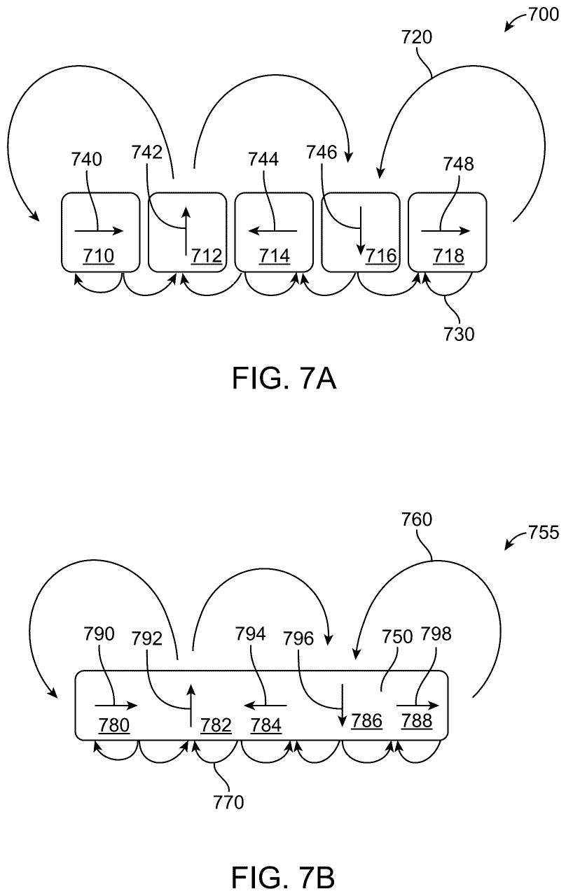

FIG. 7A illustrates a Halbach array formed of a number of magnets and FIG. 7B illustrates a unitary magnet implemented to mimic a Halbach array that can replace the magnets of FIG. 7A. FIG. 7A illustrates a Halbach array 700 formed of a number of magnets including magnet 710, magnet 712, magnet 714, magnet 716, and magnet 718. The magnets of Halbach array 700 can be positioned such that their polarity generated by easy axis directions rotate in a counterclockwise manner from left to right (as drawn.) For example, magnet 710 can have an easy axis direction generating a polarity 740 that extends horizontally in a direction to the right (as drawn.) Magnet 712 can have an easy axis direction generating a polarity 742 that is rotated counterclockwise 90 degrees relative to polarity 740 of magnet 710 to the upward direction. Magnet 714 can have a polarity 744 that is rotated counterclockwise 90 degrees relative to polarity 742 of magnet 712. Similarly, magnet 716 can have polarity 746 that is rotated counterclockwise 90 degrees relative to polarity 744 of magnet 714, while magnet 718 can have polarity 748 that is rotated counterclockwise 90 degrees relative to polarity 746 of magnet 716.

The arrangement of Halbach array 700 can generate easy axis directions 720 on a top side that are stronger than easy axis directions 730 on a bottom side. That is, the magnetic field from a bottom of the Halbach array 700 can be rerouted to the top side. This can increase a magnetic field at a top of the Halbach array 700 in an efficient way. It can also reduce stray flux at a bottom of the Halbach array 700.

It can be difficult to manufacture Halbach array 700. For example, the various magnets might need to be held in place relative to each other with a base or other substrate. This can be difficult since the magnets in Halbach array 700 can strongly repel each other. The magnets can be held together using an adhesive, such as an epoxy or other material. A stronger adhesive might need to be used due to the repulsion of the magnets in Halbach array 700 to each other. The use of these materials can lower an efficiency and field strength of Halbach array 700. To compensate, the magnets can be made larger, though this can increase the space that Halbach array 700 occupies in an electronic device and can increase the amount of resources consumed in their manufacture. Accordingly, embodiments of the present invention can replace the multiple magnets used to form Halbach array 700 with a single, unitary magnet. An example is shown in the following figure.

FIG. 7B illustrates a unitary magnet implemented to mimic a Halbach array that can replace the magnets of FIG. 7A. The use of a unitary magnet 750 can eliminate or reduce the complexities that occur due to repulsion of magnets and the need for a strong adhesive in manufacturing Halbach array 700 (shown in FIG. 7A.) Halbach array 755 can be implemented as a unitary magnet 750. Note that magnet 750 can be referred to here as a Halbach array 755 even though it is implemented as a single magnet and not an array of magnets. Unitary magnet 750 can include several portions having different easy axes resulting in different polarity directions. That is, each of the several portion can have different directions for their easy axis directions. The grains of unitary magnet 750 can be positioned such that their polarities rotate in a counterclockwise manner from left to right. For example, section 780 of unitary magnet 750 can have polarity 790 that extend horizontally in a direction to the right (as drawn.) Section 782 can have polarity 792 that is rotated counterclockwise 90 degrees relative to polarity 790 of section 780 to the upward direction. Section 784 can have polarity 794 that is rotated counterclockwise 90 degrees relative to polarity 792 of section 782. Similarly, section 786 can have polarity 796 that is rotated counterclockwise 90 degrees relative to polarity 794 of section 784, while section 788 can have polarity 798 that is rotated counterclockwise 90 degrees relative to polarity 796 of section 786.

The arrangement of sections in unitary magnet 750 can generate a magnetic field 760 on a top side that are stronger than the magnetic field 770 on a bottom side. That is, the magnetic field 770 from a bottom of the unitary magnet 750 can be rerouted to the top side. This can increase the magnetic field 760 at a top of the unitary magnet 750 in an efficient way. It can also reduce stray flux at a bottom of the unitary magnet 750.

Using unitary magnet 750 for Halbach array 755 can simplify manufacturing of an electronic device. For example, a group of magnets don't need to be aligned and fixed to each other as in Halbach array 700 (shown in FIG. 7A.) This can reduce assembly time, increase yield, decrease rework, and conserve resources. Unitary magnet 750 can be more efficient, thereby allowing Halbach array 755 to be smaller than Halbach array 700, which can allow the electronic to be smaller, include more functionality, or both.

Unitary magnet 750 can be formed by a metal-injection molding or other molding process. Unitary magnet 750 can be referred to as a neodymium magnet. That is, the magnet 750 can be formed of neodymium, iron, and boron. In these and other embodiments of the present invention, other materials, such as rare earth materials can be used, such as samarium-cobalt, manganese-bismuth, or other material. Ferritic materials can also be used. Powdered neodymium, iron, and boron (NdFeB) can be formed by grinding crystalline NdFeB and combined with a binder to generate a feedstock. The feedstock can be heated and injected into a mold. A magnetic field can be applied to the mold to enforce nonparallel easy axes. An example is shown in FIG. 8. The molded magnet can be debound, that is the binding agent can be removed. The molded magnet can be sintered and the result can then be used in an electronic device. Portions of the molded magnet, such as gate vestiges and parting lines, can be removed before or after sintering and reused as feedstock. The molded magnet can include voids or open areas within its volume. For example, unitary magnet 750 can include two, three, four, or other percent voids.

A magnetic field can be applied to magnet 750 during the molding process to enforce the various pole directions for sections of magnet 750. That is, a magnetic field can be applied to magnet 750 during the molding process to enforce the rotating polarities for unitary magnet 750. The magnetic field can be generated using permanent magnets, pole pieces, electromagnets, or combinations of these and other magnetic structures. In this example, the easy axes can be enforced in various ways during the manufacturing process. For example, a plurality of magnets arranged as Halbach arrays can be placed on top and bottom sides of unitary magnet 750 (where down is the direction into FIG. 6B.) The magnets on the sides of unitary magnet 750 can have the same pattern as shown for unitary magnet 750. A resulting magnetic field can align grains of unitary magnet 750 during molding such that the finished unitary magnet 750 has the desired rotating polarity.

These and other unitary magnets can be formed by a metal-injection molding or other molding process. Using a metal-injection molding or other molding process can provide a unitary magnet with a shape, features, and nonlinear or nonparallel magnetic field characteristics that might be impossible or difficult to otherwise manufacture, particularly in large volumes. These and other unitary magnets can be neodymium magnets. These and other unitary magnets can be formed of neodymium, iron, and boron. In these and other embodiments of the present invention, other materials, such as rare earth materials can be used, such as samarium-cobalt, manganese-bismuth, or other material. Ferritic materials can also be used.

In these and other embodiments of the present invention, powdered neodymium, iron, and boron can be combined with a binder to generate a feedstock. The feedstock can be heated and injected into a mold. A magnetic field can be applied to the mold to enforce nonparallel easy axes. The molded magnet can be debound, that is the binding agent can be removed. The molded magnet can be removed from the mold before debinding. The molded magnet can be sintered and the result can then be used in an electronic device. The molded magnet can also be removed from the mold before sintering. Portions of the molded magnet, such as gate vestiges and parting lines, can be removed before or after sintering and reused as feedstock. The molded magnet can include voids or open areas within its volume. For example, unitary magnet 100 can include two, three, four, or other percent voids.

A magnetic field can be applied to the magnet during the molding processes to enforce a nonlinear pole direction for a molded magnet. That is, a magnetic field can be applied to magnet 100 during the molding process to enforce a nonlinear easy axis for magnet 100. These magnets can be permanent magnets, magnetic elements such as pole pieces, electromagnets, or other structures capable of conveying or generating a magnetic field, or a combination of these. An example of this process is shown in the following figure.

FIG. 8 illustrate a molding system that can be used in the manufacturing of a unitary molded magnet according to an embodiment of the present invention. Molding system 800 can include mold 810 having a top portion 812 and a bottom portion 814. Top portion 812 and bottom portion 814 can form cavity 816 and gate 818. Coil 830 and coil 832 can be included in mold 810 or can be formed or placed around mold 810.

During manufacturing, a powder made by grinding neodymium, iron, and boron (NdFeB), which can be a crystal. The powdered neodymium, iron, and boron can be combined with a binder to generate a feedstock. The feedstock can be heated and injected through gate 818 into cavity 816 in mold 810 to form magnet 820. Current can flow in either or both coil 830 and coil 832 to generate magnetic field 834. Field lines of magnetic field 834 can be nonparallel. Magnetic field 834 can be present while magnet 820 is being formed. The easy axes of magnet 820 can follow the field lines of magnetic field 834. Magnetic field 834 can be generated by coil 830 and coil 832, or other coils, permanent magnets, magnets, magnetic elements such as pole pieces, electromagnets, or other structures capable of conveying or generating a magnetic field, or a combination of these.

After magnet 820 is formed, the binder can be removed by a debinding process. The debinding process can leave voids in magnet 820. These voids can be removed by sintering magnet 820. Excess portions on magnet 820, such as gate portion 822 and parting lines (not shown) between top portion 812 and bottom portion 814 of mold 810, can be removed, for example by trimming. In these and other embodiments of the present invention, magnet 820 can be removed from mold 810 during the debinding process and the sintering process. While magnet 820 is in mold 810, magnetic field 834 can be generated by either or both coil 830 and coil 832. Alternatively, magnetic field 834 can be generated by permanent magnets, magnets, magnetic elements such as pole pieces, electromagnets, or other structures capable of conveying or generating a magnetic field, or a combination of these. Magnetic field 834 can be a constant or variable magnetic field during these processes.

In this example, a mixture of powdered neodymium, iron, and boron (NdFeB) can be formed by grinding crystalline NdFeB permanent and combined with a binder to generate a feedstock for injection into mold 810. In these and other embodiments of the present invention, other materials, such as rare earth materials can be used. Samarium-cobalt, manganese-bismuth, or other materials can be used. Ferritic materials can also be used.

Mold 810 can be formed of various materials that do not react with the feedstock being used. For example, mold 810 can be formed of steel, stainless steel, cast iron, iron, or other materials. Either or both coil 830 and coil 832 can be in mold 810, for example mold 810 can be formed or assembled around coil 830 and coil 832. Either or both coil 830 and coil 832 can instead be positioned around mold 810. While two coils, coil 830 and coil 832, are shown in this example, molding system 800 can include one, three, four, five, or more than 5 coils. Also, while coil 830 and coil 832 are shown as being in parallel, coil 830 and coil 832 can have other spatial relationships, for example, they can be oblique, orthogonal, offset, or have other spatial relationship.

Coil 830 and coil 832 can share the same current, or they can have separate currents, and the currents can have the same or different directions, durations, and magnitudes. Either or both of these currents can be constant or variable, that is, their magnitude can change over time. Either or both of these currents can be on for a duration that is at least a significant portion of the time necessary for the molding process. Either or both of these currents can be on for one or more short durations of a comparatively larger magnitude, or a combination of such currents longer and shorter durations can be used during the molding process. Coil 830 and coil 832 can be connected in series or parallel to a current source (not shown.) Coil 830 and coil 832 can each be connected to a separate current source.

After magnet 820 is molded, the binder can be removed and magnet 820 can be sintered. An example is shown in the following figure.

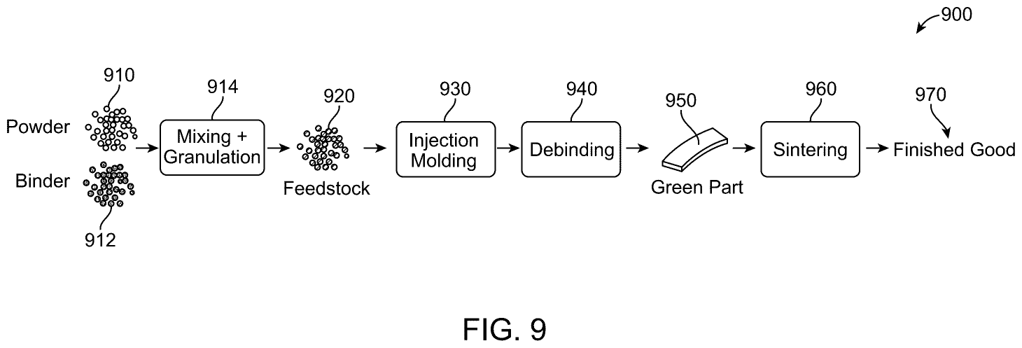

FIG. 9 illustrates processes involved in manufacturing a magnet according to an embodiment of the present invention. During manufacturing, powder 910 can be made by grinding neodymium, iron, and boron (NdFeB), which can be a crystal, into a powder that can consist mostly of single grains. The neodymium, iron, and boron powder 910 can be combined with a binder 912 to generate feedstock 920. The binder 912 can be formed of a polymer, such as polyphenylene sulfide (PPS), polyamide or nylon, polyvinyl butyral, rubber. Powder 910 and binder 912 can be mixed and granulated in process 914 to produce feedstock 920 for molding. Feedstock 920 can be heated and then injection molded into a mold, such as mold 810 (shown in FIG. 8), to form what is to become magnet 820 (both shown in FIG. 8) in molding process 930. During molding process 930, mold 810 can be in a magnetic field, such as magnetic field 834 (id.) Magnetic field 834 can be a constant or variable magnetic field. Magnetic field 834 can be generated currents in either or both coil 830 and coil 832 and can be present during some or all of the molding process. Magnetic field 834 can be generated by one or more short bursts of current in either or both coil 830 and coil 832. Magnetic field 834 can be generated by coil 830 and coil 832, or other coils, permanent magnets, magnets, magnetic elements such as pole pieces, electromagnets, or other structures capable of conveying or generating a magnetic field, or a combination of these.

After molding, the molded material can be debound in debinding process 940. Debinding process 940 can be a thermal debinding. Debinding process 940 can instead be a catalytic debinding process, where the molded material is debound in a gaseous acid environment, where the acid is nitric acid, oxalic acid, or other acid. The debinding process 940 can be performed with a solvent, such as acetone, heptane, or other ketone.

After debinding process 940, the result, which can be referred to as a green part 950, can be sintered in sintering process 960 to produce the finished good 970. The sintering process can remove some or all of the voids that are created during the debinding process 940. In these and other embodiments of the present invention, magnet 820 can include two, three, four, or other percent voids. The molded material can be removed from mold 810 for the debinding process 940 and sintering process 960.

After sintering process 960, the grains of finished good 970 can remain aligned forming the desired easy axes. The sintering process 960 can remove some or all of the magnetism of finished good 970. The finished good 970 can be magnetized at this time to complete magnet 820. Alternatively, the finished good 970 can be placed in an electronic device while it is still demagnetized and easy to manipulate. Once installed, the finished good 970 can be magnetized to complete magnet 820. In these and other embodiments of the present invention, the finished good 970 can be magnetized at other times after sintering to complete magnet 820.

During molding, coil 830 and coil 832 can share the same current, or they can have separate currents, and the currents can have the same or different directions, durations, and magnitudes. Either or both of these currents can be constant or variable, that is, their magnitude can change over time. Either or both of these currents can be on for a duration that is at least a significant portion of the time necessary for the molding process. Either or both of these currents can be on for one or more short durations of a comparatively larger magnitude, or a combination of such currents longer and shorter durations can be used during the molding process.

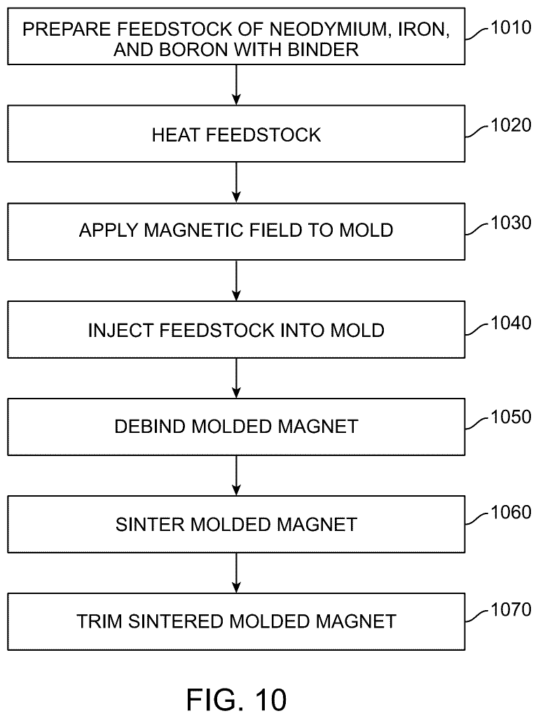

FIG. 10 illustrates a method of manufacturing a magnet according to an embodiment of the present invention. In act 1010, a feedstock comprising a mixture of neodymium, iron, and boron, as well as a binder, can be provided. The neodymium, iron, and boron can be a powder that is formed by grinding crystalline NdFeB into a powder that can consist mostly of single grains. This powder can be combined with a binder, then mixed and granulated to form the feedstock. The feedstock can be heated in act 1020. In act 1030, a magnetic field can be applied to a mold. The magnetic field can be generated by one or more coils, permanent magnets, magnets, magnetic elements such as pole pieces, electromagnets, or other structures capable of conveying or generating a magnetic field, or a combination of these. In act 1040, the feedstock can be injected into the mold. In these and other embodiments of the present invention, the feedstock can be injected into a mold and then the magnetic field can be applied, or these two events can occur simultaneously or near simultaneously.

In act 1050, some or all of the binder material can be removed from the molded magnet. The molded magnet can be sintered in act 1060. The sintered magnet can be trimmed in act 1070. The sintered magnet can be magnetized at this or a later time, or the sintered magnet can be placed in an electronic device then magnetized. Placing the sintered magnet in an electronic device before magnetization can make the sintered magnet easier to handle.

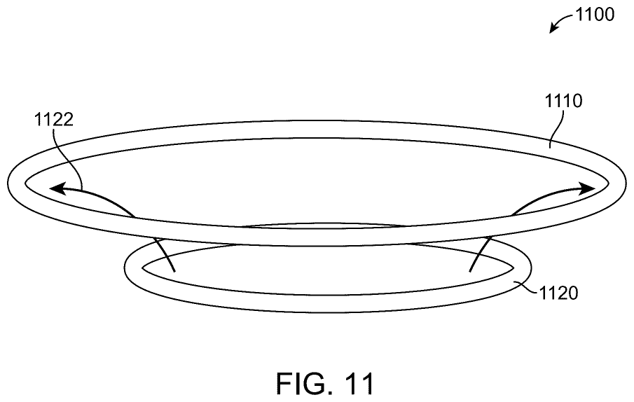

FIG. 11 illustrates a configuration for a coil that can be used during the manufacturing of magnets according to an embodiment of the present invention. In this example, molding system 1100 can include magnet 1110 and coil 1120. Magnet 1110 can be formed in a mold, such as mold 810 (shown in FIG. 8) while current is running in coil 1120 to generate magnetic field 1122. Coil 1120 can generate magnetic field 1122 that can align the easy axes of magnet 1110 in a radial manner while being molded. For example, magnetic field 1122 can enforce easy axis directions in a radial, nonparallel manner as shown by easy axis directions 448 as shown in FIG. 4B.

The current in coil 1120 can have a long duration that extends during some or all of the molding process. The current in coil 1120 can be one or more short bursts, or these different types of current wave forms can be combined. The current in coil 1120 can vary over time in magnitude. The current in coil 1120 can be present and forming magnetic field 1122 during some of all of the molding process as described above.

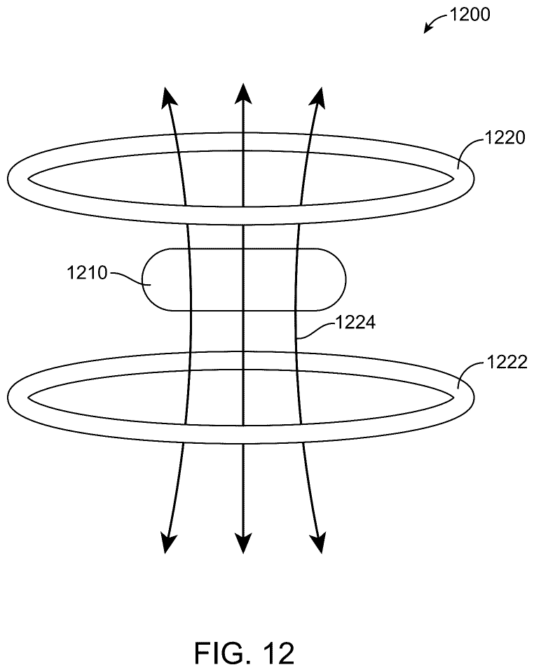

FIG. 12 illustrates a configuration for coils that can be used during the manufacturing of magnets according to an embodiment of the present invention. In this example, molding system 1200 can include magnet 1210, coil 1220, and coil 1222. Magnet 1210 can be formed in a mold, such as mold 810 (shown in FIG. 8) while current is running in coil 1220 and coil 1222 to generate magnetic field 1224. Coil 1220 and coil 1222 can generate magnetic field 1224 that can align the easy axes of magnet 1210 in a diverging, nonparallel manner while being molded.

Coil 1220 and coil 1222 can carry the same or different currents. The currents can flow in the same or opposite directions. Either or both the currents in coil 1220 and coil 1222 can have a long duration that extends during some or all of the molding process. Either or both the currents in coil 1220 and coil 1222 can be one or more short bursts, or these different types of current wave forms can be combined. Either or both the currents in coil 1220 and coil 1222 can vary over time in magnitude. Either or both the current in coil 1220 and the current in coil 1222 can be present and forming magnetic field 1224 during some of all of the molding process as described above. Either or both coil 1220 and coil 1222 can be connected in series or parallel to a current source (not shown.) Either or both coil 1220 and coil 1222 can each be connected to corresponding separate current sources.

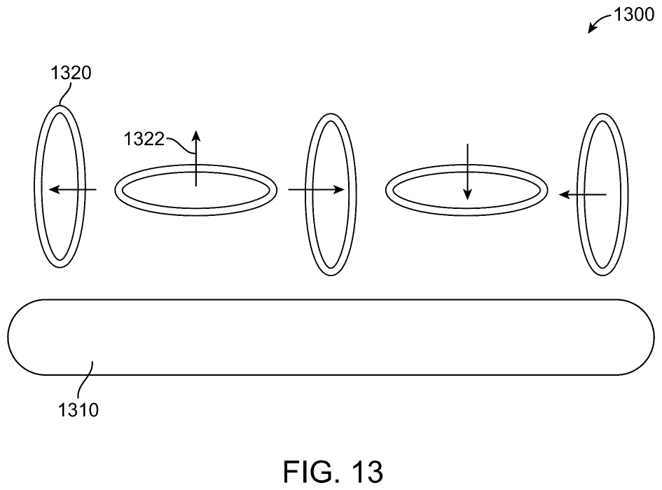

FIG. 13 illustrates a configuration for coils that can be used during the manufacturing of magnets according to an embodiment of the present invention. In this example, molding system 1300 can include magnet 1310 and coils 1320. Magnet 1310 can be formed in a mold, such as mold 810 (shown in FIG. 8) while current is running in coils 1320 to generate magnetic fields 1322. Coils 1320 can generate magnetic fields 1322 that can align the easy axes of magnet 1310 as a Halbach array while being molded. For example, magnetic fields 1322 can enforce easy axis directions arranged as a Halbach array as shown by polarities 790 through 798 in FIG. 7B.

Coils 1320 can each carry the same or different currents. The currents can flow in various directions. One or more of the currents in coils 1320 can have a long duration that extends during some or all of the molding process. One or more of the currents in coils 1320 can be one or more short bursts, or these different types of current wave forms can be combined. One or more of the currents in coils 1320 can vary over time in magnitude. One or more of the currents in coils 1320 can be present and forming magnetic field 1224 during some of all of the molding process as described above. One or more coils 1320 can be connected in series or parallel to a current source (not shown.) One or more coils 1320 can each be connected to corresponding separate current sources.

These and other embodiments of the present invention can provide other shaped magnets. For example, embodiments can provide conventional bar magnets. Such a bar magnet can be made more efficiently, since bar magnets that are commercially available might not be available in an exact size that is needed, so material would still need to be removed to form the bar magnet. Also, embodiments can provide a stronger magnet that might be commercially available. Other shapes, such as plus-sign or “X” shaped magnets. These magnets can have a first polarity at two adjacent ends, or they can have a first polarity at two opposing ends, while the remaining ends have the second polarity. Annular magnets, “S” shaped magnets, horseshoe-shaped magnets, or other shaped magnets can also be formed using embodiments of the present invention.

Embodiments of the present invention can provide unitary magnets having different easy axis directions at different locations. Also, embodiments can provide unitary magnets having one polarity direction throughout the magnet. Such a magnet can be made more efficiently, since magnets that are commercially available might not be available in an exact size that is needed, so material would still need to be removed to form a magnet having one polarity direction. Also, embodiments can provide a stronger magnet that might be commercially available.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

1. An electronic device comprising:
a magnet formed as a unitary structure wherein the magnet comprises a first portion and a second portion,
wherein the first portion has a first easy axis and the second portion has a second easy axis, and the first easy axis and the second easy axis are non-parallel.

2. The electronic device of claim 1 wherein the magnet is formed by metal-injection-molding.

3. The electronic device of claim 2 wherein the magnet is a rare earth magnet.

4. The electronic device of claim 2 wherein the magnet is formed of neodymium, iron, and boron.

5. The electronic device of claim 4 wherein the magnet comprises at least one curved surface.

6. The electronic device of claim 5 wherein the magnet comprises at least two percent voids.

7. An electronic device comprising:
a magnet formed as a unitary structure wherein the magnet comprises a first portion and a second portion,
wherein the first portion has easy axis directions along a first axis,
the second portion has easy axis directions along a second axis,
wherein the first axis and the second axis intersect.

8. The electronic device of claim 7 wherein the magnet is formed by metal-injection-molding.

9. The electronic device of claim 8 wherein the magnet is formed of neodymium, iron, and boron.

10. The electronic device of claim 9 wherein the magnet is shaped as an arc of a circle, the circle having a center, and wherein the first axis and the second axis intersect at the center of the circle.

11. The electronic device of claim 10 wherein the magnet comprises at least two percent voids.

12. An electronic device comprising:
a magnet formed as a unitary structure using metal-injection molding, wherein the magnet is formed of Neodymium, Iron, and Boron, the magnet comprises a plurality of easy axes, and the plurality of easy axes are not parallel.

13. The electronic device of claim 12 wherein adjacent surfaces of the magnet form one of an acute or obtuse angle.

14. The electronic device of claim 12 wherein easy axis directions for the magnet enter a first surface, turn at least 180 degrees, and exit the first surface.

15. The electronic device of claim 14 wherein the first surface is curved.

16. The electronic device of claim 12 wherein a first side of the magnet has easy axis directions in a first direction, a second side of the magnet has easy axis directions in a second direction, and a middle of the magnet has easy axis directions in a third direction,
wherein the third direction is from the second side of the magnet to the first side of the magnet, and the first direction and the third direction converge in one or an acute or obtuse angle.

17. The electronic device of claim 12 wherein a surface of the magnet comprises an array of groups of easy axis directions, wherein each group of easy axis directions has a first polarity or a second polarity, wherein each row in the array comprises a group of easy axis directions having the first polarity and a group of easy axis directions having the second polarity.

18. The electronic device of claim 17 wherein each column in the array comprises a group of easy axis directions having the first polarity and a group of easy axis directions having the second polarity.

19. The electronic device of claim 12 wherein the magnet mimics a Halbach array.

20. The electronic device of claim 19 wherein a strength of a magnetic field on a first side of the magnet is stronger than the magnetic field on a second side of the magnet.

21-22. (canceled)
